(19) United States
(12) Patent Application Publication
(10) Pub. No.: US 2026/0012870 A1
(43) Pub. Date: Jan. 8, 2026

(54) HANDOVER SUPPORTING DEVICE AND METHOD

(71) Applicant: SK TELECOM CO., LTD., Seoul (KR)

(72) Inventor: Hyoungjoo LEE, Seoul (KR)

(21) Appl. No.: 18/992,390

(22) PCT Filed: Sep. 5, 2023
(86) PCT No.: PCT/KR2023/013280

§ 371 Date: Jan. 8, 2025

(30) Foreign Application Priority Data
Sep. 5, 2022 (KR) 10-2022-0112415

(51) Int. Cl. H04W 36/30

(52) U.S. Cl. CPC H04W 36/30

(57) ABSTRACT

Disclosed herein is a method of determining a handover, the method being performed by an apparatus for determining a handover, according to an embodiment. The method includes obtaining information on a movement direction of an aircraft operating a flight along a preset flight route within a service region of an airborne network that includes a plurality of wireless cells, determining a mode among a first mode and a second mode each having different handover conditions between the plurality of wireless cells based on the information on the movement direction, and determining whether a handover of the aircraft or a communication device installed at the aircraft for airborne network is performed according to a handover condition corresponding to the determined mode.

### CROSS-REFERENCE TO RELATED APPLICATION

The present application is a national stage filing under 35 U.S.C § 371 of PCT application number PCT/KR2023/013280 filed on Sep. 5, 2023 which is based upon and claims the benefit of priority to Korean Patent Application No. 10-2022-0112415 filed on Sep. 5, 2022 in the Korean Intellectual Property Office. All of the aforementioned applications are hereby incorporated by reference in their entireties.

### TECHNICAL FIELD

The present invention relates to an apparatus for determining a handover between wireless cells in an airborne network and a method through which the apparatus supports a handover.

### BACKGROUND ART

Recently, there has been increasing interest upon urban air mobility (UAM), particularly in developed countries, and Korea has also conducted comprehensive demonstrations of Korean-style urban air mobility and is now approaching the stage of commercialization.

According to the technological roadmap for Korean-style urban air mobility, the flight altitudes of UAM aircraft is expected to range from approximately 300 meters to 600 meters, with a maximum flight speed of around 320 km/h. It is anticipated that the UAM aircraft will be operated along designated flight routes.

In the flight routes of UAM aircraft, an airborne network is planned to be operated to support data transmission and reception services for UAM aircraft. The base stations for the airborne network will be responsible for communications for a defined service cell range, enabling UAM aircraft to perform communications within the service coverage of the airborne network provided by the base stations for airborne network. These base stations for airborne network perform wireless mutual communications with communication devices for airborne network on-board the corresponding aircraft to provide wireless communication services to multiple aircraft operating in flight within the wireless cell.

Meanwhile, in 3GPP 4G/5G, the cell coverage, which represents the communication range of a base station, varies depending on the installation environment (e.g., urban, suburban, rural). For the purpose of communication performance analysis, the 3GPP standard defines different base station intervals for each installation environment. In general, the distance between base stations is narrower in urban areas with a high number of users, and wider in rural areas with fewer users.

In the UAM operational system, the flight operations of UAM aircraft are fundamentally in consideration of the high-density urban environment. Although the base stations are spaced farther apart, assuming fewer users compared to ground networks, frequent handovers where the aircraft move across cell boundaries to other cells are bound to occur due to the high flight speed of aircraft.

When the general handover procedure is applied in a ground network environment, UAM aircraft can deliver measurement reports on the strength of a wireless channel to a serving cell. The base station of the serving cell may prepare for the handover procedure when the signal strength of the serving cell falls below a specific threshold or when the signal strength of the serving cell is lower than that of a target cell. Once the corresponding preparation is complete, the base station of the serving cell can transmit a handover command to the UAM aircraft. The UAM aircraft can disconnect the uplink/downlink connection with the serving cell and perform the access procedure for the target cell. After the access procedure is successfully performed, the UAM aircraft can transmit and receive data through the uplink/downlink newly connected to the target cell.

### DISCLOSURE

### Technical Problem

As described above, a maximum flight speed of the UAM aircraft is around 320 km/h as mentioned earlier, which may be expected to lead to rapid changes in the wireless channel environment for both the serving cell and the target cell. When the UAM aircraft passes through the serving cell and approaches the target cell, the signal strength of the serving cell may suddenly deteriorate, in which case the handover to the target cell needs to be performed rapidly. In such UAM flight scenarios, unlike handovers in the ground network, handover processing suitable for the airborne network environment is required.

According to an embodiment, there is provided an apparatus and method for determining a handover that applies different handover conditions according to the movement direction of aircraft operating a flight over a service region of an airborne network.

However, the problem to be solved by the present disclosure is not limited to that mentioned above, and other problems to be solved that are not mentioned may be clearly understood by those of ordinary skill in the art to which the present disclosure belongs from the following description.

### Technical Solution

According to a first aspect, there is provided a method of determining a handover, the method being performed by an apparatus for determining a handover. The method may include obtaining information on a movement direction of an aircraft operating a flight along a preset flight route within a service region of an airborne network that includes a plurality of wireless cells, determining a mode among a first mode and a second mode each having different handover conditions between the plurality of wireless cells based on the information on the movement direction and determining whether a handover of the aircraft or a communication device installed at the aircraft for airborne network is performed according to a handover condition corresponding to the determined mode.

According to a second aspect, there is provided a method of supporting a handover, the method being performed by an apparatus for supporting a handover. The method may include obtaining information on a movement direction of an aircraft operating a flight along a preset flight route within a service region of an airborne network that includes a plurality of wireless cells and determining a timing of a handover based on the information on the movement direction.

According to a third aspect, there is provided an apparatus for determining a handover. The apparatus may include a communication unit configured to perform communication with aircraft operating a flight over a service region of an airborne network that includes a plurality of wireless cells along a preset flight route, and a processor unit configured to control the communication unit, in which the processor unit, after obtaining information on a movement direction of the aircraft, may determine a mode among a first mode and a second mode each having different handover conditions between a plurality of wireless cells based on the information on the movement direction, and determine whether a handover of the aircraft or a communication device installed at the aircraft for airborne network is performed according to a handover condition corresponding to the determined mode.

According to a fourth aspect, there is provided an apparatus for supporting a handover. The apparatus may include a communication unit configured to perform communication with aircraft operating a flight over a service region of an airborne network that includes a plurality of wireless cells along a preset flight route, and a processor unit configured to control the communication unit, in which the processor unit, after obtaining information on a movement direction of the aircraft, may determine a timing of a handover based on the information on the movement direction.

According to a fifth aspect, there is provided a non-transitory computer-readable storage medium storing a computer program. The computer program may include instructions to allow the processor to perform a method of determining a handover, the method including obtaining information on a movement direction of an aircraft operating a flight along a preset flight route within a service region of an airborne network that includes a plurality of wireless cells, determining a mode among a first mode and a second mode each having different handover conditions between the plurality of wireless cells based on the information on the movement direction and determining whether a handover of the aircraft or a communication device installed at the aircraft for airborne network is performed according to a handover condition corresponding to the determined mode.

### Advantageous Effects

According to an embodiment, in determining a handover between wireless cells of an airborne network for aircraft such as UAM, a timing of a handover may be determined based on movement direction. For example, a different handover condition can be applied depending on the movement direction, thereby enabling handover processing optimized for an airborne network environment. For example, when aircraft is moving in a direction in which the strength of signal beam of the serving cell strengthens as it moves, a handover error may occur due to the characteristics of the airborne network environment in which the signal beam of the serving cell, which was strong at the boundary region of the serving cell and the target cell, is suddenly cut off when the normal handover procedure in the ground network environment is applied. However, there is an effect in that smooth handover is supported through handover processing optimized for the characteristics of the airborne network environment.

### DESCRIPTION OF DRAWINGS

FIG. 1 is a configuration diagram of a UAM operation system according to an embodiment of the present invention.

FIG. 2 is a configuration diagram of an apparatus for determining a handover according to an embodiment of the present invention.

FIG. 3 is a flowchart for describing a method of determining a handover according to an embodiment of the present invention.

FIG. 4 is a flowchart for describing a method of determining a handover according to another embodiment of the present invention.

FIG. 5 is a flowchart for describing a method of determining a handover according to still another embodiment of the present invention.

FIG. 6 is a conceptual view for describing a correlation between a direction of a base station signal beam and a movement direction of UAM aircraft in embodiments of the present invention.

### MODE FOR DISCLOSURE

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

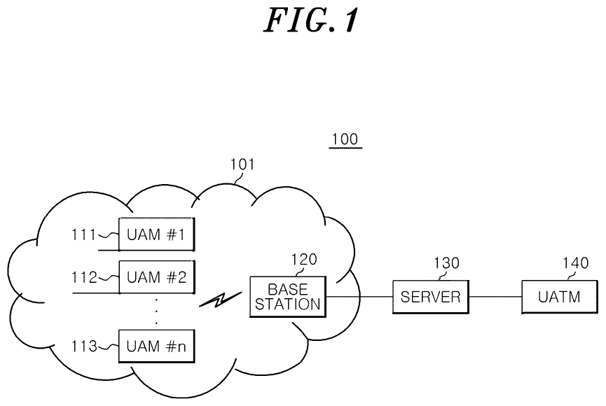

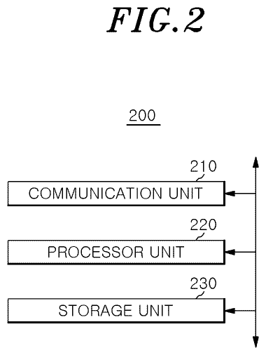

FIG. 1 is a configuration diagram of a UAM operation system according to an embodiment of the present invention, and FIG. 2 is a configuration diagram of an apparatus for determining a handover according to an embodiment of the present invention.

A UAM operation system 100 may include a plurality of UAM aircraft 111, 112, and 113, a base station 120, a server 130, and an unmanned aircraft system traffic management (UATM) 140. FIG. 1 illustrates three UAM aircraft 111, 112, and 113, but this is just an example and various modifications and variation can be made on the number of UAM aircraft. In addition, although a single base station 120 is exemplarily illustrated, an airborne network 101 may be formed by a collection of wireless cells each provided by a plurality of base stations 120. For example, the plurality of base stations 120 may provide at least one wireless cell of a plurality of airborne network wireless cells disposed in an advancing direction along flight routes of the UAM aircraft 111, 112, and 113, respectively, as service coverage.

The plurality of UAM aircraft 111, 112, and 113 may be operated along flight routes. Here, the flight route may be a route corresponding to flight route information preset by a provider of service for UAM (PSU) in the UATM 140. In addition, the plurality of UAM aircraft 111, 112, and 113 may use the airborne network 101 within wireless cell coverage by the base station 120 in an environment where wireless communications are supported. In addition, the UAM aircraft 111, 112, and 113 may perform inter-aircraft communications with other UAM aircraft. For example, the inter-aircraft communication may include, or may be one or more of, all communication methods that support a direct communication between aircraft rather than a communication link connection method (e.g., 3GPP 4G/5G) of the airborne network 101. In addition, the UAM aircraft 111, 112, and 113 may be equipped with a communication device for aircraft (not illustrated) for wireless communication with the base station 120. In addition, the UAM aircraft 111, 112, and 113 may be communicatively connected to the UATM 140 through the base station 120 and the server 130 of the airborne network 101, or may be communicatively connected to the UATM 140 through satellite communications. The communication device for aircraft (not illustrated) that may be equipped on the UAM aircraft 111, 112, and 113 may correspond to a mobile communication terminal in a general terrestrial mobile communication network such as 3GPP 4G/5G.

Meanwhile, the plurality of UAM aircraft 111, 112, and 113 may operate a flight within the airborne network 101 along flight routes defined by the preset flight route information, and may perform handovers between the plurality of wireless cells in response to a handover command from the base station 120. To this end, the UAM aircraft 111, 112, or 113 or communication device for aircraft (not illustrated) may transmit at least one of current position information, flight speed information, signal strength of a serving cell, or signal strength of a target cell on a preset flight route to the base station 120 or the UATM 140.

The base station 120 provides a mobile communication service through the airborne network 101 to UAM aircraft positioned within the wireless cell thereof among the plurality of UAM aircraft 111, 112, and 113.

Further, the base station 120 may obtain information on movement directions of the UAM aircraft 111, 112, and 113 operating a flight within a service region of the airborne network 101 and determine a timing of a handover based on movement direction. For example, the base station 120 may determine a timing of a handover based on a signal strength change of a serving cell corresponding to a distance change between an aircraft and a serving cell in a movement direction. For example, the base station 120, may determine a handover when a signal strength of a serving cell is higher than a preset threshold while an aircraft is moving in a direction where a signal strength of a serving cell increases as a distance from a based station of a serving cell increases. In addition, the base station 120 determine a mode among a plurality of handover modes based on the information on movement directions. In this case, each of the plurality of handover modes may be a mode in which the handover conditions between the plurality of wireless cells are set differently. For example, the plurality of handover modes may include a first mode and a second mode. The base station 120 according to an embodiment of the present disclosure is preferably configured to support handovers between the wireless cells of the UAM aircraft 111, 112, and 113. For example, the base station 120 may include or be in conjunction with an apparatus 200 for determining a handover in FIG. 2. A process of determining a handover by the base station 120 or the apparatus 200 for determining a handover will be described further below.

The server 130 may transmit information on the wireless cells of the airborne network 101 to the UAM aircraft 111, 112, and 113 through the base station 120 based on the flight route information on the UAM aircraft 111, 112, and 113. For example, when the airborne network 101 is implemented as 3GPP 4G/5G, the server 130 may be a mobility management entity (MME) or another entity that makes up a core network.

The PSU in the UATM 140 may determine the flight routes of the UAM aircraft 111, 112, and 113 based on relevant information such as the origin, destination, flight time, weather environment of the UAM aircraft 111, 112, and 113, and may provide the set flight routes to the server 130.

In addition, the UATM 140, like the base station 120 described above, may obtain information on movement directions of the UAM aircraft 111, 112, and 113 operating a flight within a service region of the airborne network 101 and determine a mode among a plurality of handover modes based on the information on movement directions. For example, the plurality of handover modes may include a first mode and a second mode. The UATM 140 according to an embodiment of the present disclosure is preferably configured to support handovers between the wireless cells of the UAM aircraft 111, 112, and 113. For example, the UATM 140 may include or be in conjunction with an apparatus 200 for determining a handover in FIG. 2. A process of determining a handover by the UATM 140 or the apparatus 200 for determining a handover will be described further below.

The apparatus 200 for determining a handover may include a communication unit 210 and a processor unit 220, as illustrated in FIG. 2, and may further include a storage unit 230.

The communication unit 210 may perform communication with UAM aircraft operating a flight within the service region of the airborne network.

The processor unit 220 may control the communication unit 210, and after obtaining information on a movement direction of UAM aircraft, determine a timing of a handover based on the obtained information on the movement direction. For example, processor unit 220 may determine a mode among a plurality of handover modes based on the obtained information on the movement direction. For example, the processor unit 220 may determine a mode among the first mode and the second mode.

The storage unit 230 may store various processing results by the processor unit 220 according to the control of the processor unit 220. The storage unit 230 may store a computer program including instructions that allow the processor unit 220 to perform each step according to a method of determining a handover according to the embodiment of the present invention.

An embodiment in which the apparatus 200 for determining a handover is included in or in conjunction with the UATM 140 will be described first, followed by an embodiment in which the apparatus 200 for determining a handover is included in or in conjunction with the base station 120.

According to the embodiment in which the apparatus 200 for determining a handover is included in or in conjunction with the UATM 140, the processor unit 220 may determine a timing of a handover based on the obtained information on the movement direction. For example, the processor unit 220 may determine a mode among a plurality of handover modes based on current position information and movement direction information on UAM aircraft. In addition, the processor unit 220 may determine a mode among a plurality of handover modes by further reflecting flight speed information on UAM aircraft along with current location information and movement direction information on the UAM aircraft.

According to the embodiment in which the apparatus 200 for determining a handover is included in or in conjunction with the base station 120, the processor unit 220 may determine a handover of UAM aircraft or a communication device (not illustrated) for airborne network installed at the UAM aircraft according to a handover condition of the determined handover mode.

As another example, the processor unit 220 may determine a mode among a plurality of handover modes based on directional information on a signal beam transmitted by the base station and movement direction information on UAM aircraft.

For example, the processor unit 220 may compare information on the movement direction of UAM aircraft and the directional information on the signal beam, and determine a mode among the first mode and the second mode according to a difference between the movement direction of UAM aircraft and the direction of the signal beam and a comparison result of a preset threshold. For example, the processor unit 220 may determine the handover mode to be the first mode when the two directions (that is, the movement direction of UAM aircraft and the direction of the signal beam) are the same, and determine the handover mode to be the second mode when the two directions are opposite to each other. In addition, the processor unit 220 may determine the handover mode to be the first mode when the UAM aircraft is moving in a direction in which the strength of signal beam of the serving cell weakens, and determine the handover mode to be the second mode when the UAM aircraft is moving in a direction in which the strength of signal beam of the serving cell strengthens. For example, the first mode may include, as a handover condition, at least one of when the signal strength of the serving cell is less than a preset first threshold, when the signal strength of the target cell is greater than the signal strength of the serving cell, and when the signal strength of the serving cell is less than a preset second threshold and the signal strength of the target cell is greater than a preset third threshold. Further, the second mode may include, as a handover condition, at least one of when the signal strength of the serving cell is greater than a preset fourth threshold, and when the signal strength of the target cell is greater than a preset fifth threshold. Further, the processor unit 220 may set a hysteresis value smaller for the second mode than for the first mode, and may set a filtering value, which determines the number of times reference signal received power (RSRP) and reference signal received quality (RSRQ) are averaged, greater for the second mode than for the first mode.

In the embodiment of the present disclosure, in consideration of a tilt-up angle of an antenna provided in the base station 120, an installation position of the base station 120, a movement route of UAM aircraft, and the like, it is illustrated that the processor unit 220 determine the handover mode to be the first mode or the second mode using information on whether the UAM aircraft moves in a direction in which the strength of signal beam of the serving cell weakens or in a direction in which the strength of signal beam of the serving cell strengthens, but the present disclosure is not limited thereto. Since the tilt-up angle of the antenna provided in the base station 120, the installation position of the base station 120, the movement route of UAM aircraft, and the like may be varied, various modifications may be applied by reflecting the tilt-up angle of the antenna provided in the base station 120, the installation position of the base station 120, the movement route of UAM aircraft, and the like. As an example, depending on the tilt-up angle of the antenna provided in the base station 120 or the installation position of the base station 120, the UAM aircraft may move in a direction in which the strength of signal beam of the serving cell gradually strengthens until a specific position, and after reaching that specific position, the UAM aircraft may move in a direction in which the strength of signal beam of the serving cell gradually weakens and move to a handover region in which the signal of the target cell is received. In such an environment, the processor unit 220 may identify directional information on the signal beam based on the tilt-up angle of the antenna provided in the base station 120 or the installation position of the base station 120, and may determine the mode by reflecting the identified directional information on the signal beam.

Further, the tilt-up angle of the antenna provided in the base station 120, the installation position of the base station 120, and the like may be set in advance, so that information related thereto may be preset and provided. Further, since the UAM aircraft moves along a preset route, a remaining distance may be calculated from a current position of the UAM aircraft to a boundary between the serving cell and the target cell. Further, since the UAM aircraft moves along a preset route, a remaining distance may be calculated from a current position of the UAM aircraft to a boundary between the serving cell and the target cell. Therefore, the processor unit 220 may determine an occasion to request a handover based on the remaining distance from the current position of the UAM aircraft to the boundary between the serving cell and the target cell. As an example, the processor unit 220 may request a handover on an occasion of reaching a first remaining distance in the first mode, and may request a handover on an occasion of reaching a second remaining distance in the second mode. Since the handover mode is determined to be the first mode when the UAM aircraft is moving in a direction in which the strength of signal beam of the serving cell weakens, and the handover mode is determined to be the second mode when the UAM aircraft is moving in a direction in which the strength of signal beam of the serving cell strengthens, the signal beam of the serving cell may reach a relatively long distance in the first mode, but only a relatively short distance in the second mode. With this in consideration, the first remaining distance may be set relatively greater than the second remaining distance.

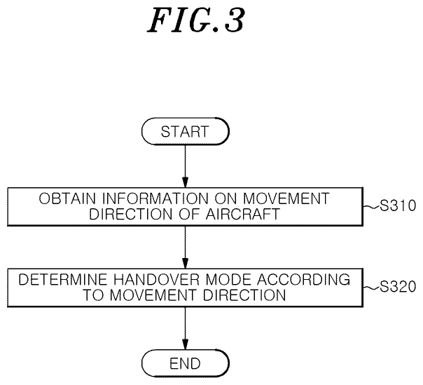

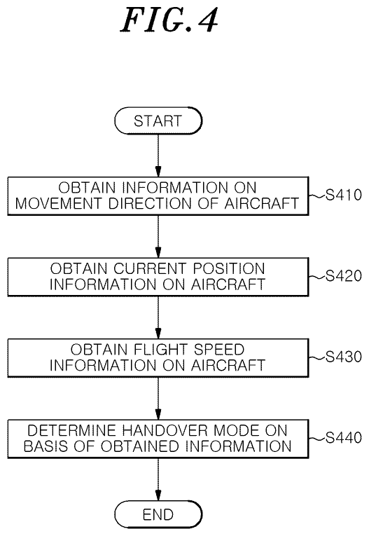

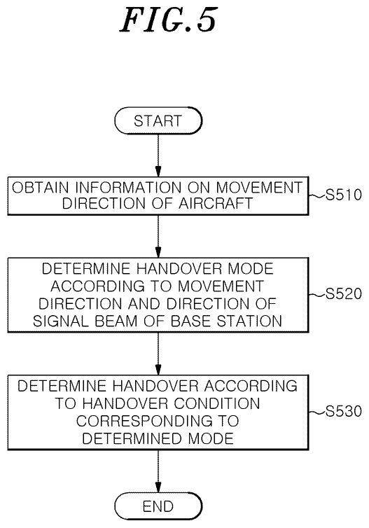

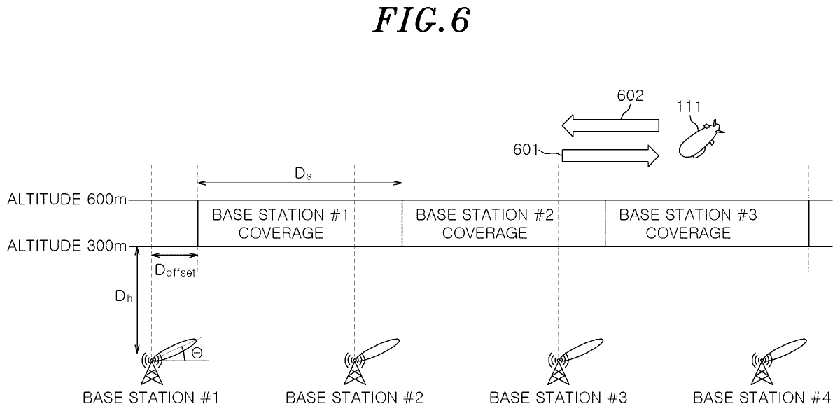

FIG. 3 is a flowchart for describing a method of determining a handover according to an embodiment of the present invention, FIG. 4 is a flowchart for describing a method of determining a handover according to another embodiment of the present invention, and FIG. 5 is a flowchart for describing a method of determining a handover according to still another embodiment of the present invention. Here, FIG. 3 illustrates steps that are commonly performed in the embodiments of FIG. 4 and FIG. 5. FIG. 6 is a conceptual view for describing a correlation between a direction of a base station signal beam and a movement direction of UAM aircraft in embodiments of the present invention.

Hereinafter, with reference to FIGS. 1 to 6, a process of supporting, by the apparatus of determining a handover, a handover of UAM aircraft or the communication device for airborne network installed at the UAM aircraft in a UAM operation system will be described in more detail, for each embodiment. In the description of the embodiments below, it will be exemplarily described that one of the first mode and the second mode is determined as a plurality of handover modes having different handover conditions, but the number of the plurality of handover modes is not limited to two. That is, the number of the plurality of handover modes may be three or more.

### <First Embodiment>: FIG. 1, FIG. 2, FIG. 3, FIG. 4, and FIG. 6 are Referenced

The UAM aircraft 111, 112, and 113 operate a flight over the service region of the airborne network 101 along the preset flight routes, and transmit information on the movement direction of the UAM aircraft 111, 112, and 113 to the apparatus 200 for determining a handover that is included in the UATM 140 or in conjunction with the UATM 140.

Then, the communication unit 210 of the apparatus 200 for determining a handover receives and transmits information on the movement direction of the UAM aircraft 111, 112, and 113 to the processor unit 220 (S310).

Next, the processor unit 220 determine a mode among the first mode and the second mode each having different handover conditions between the plurality of wireless cells based on the information on the movement direction of the UAM aircraft 111, 112, and 113 (S320).

Further, the processor unit 220 may control the communication unit 210 to transmit information on the handover mode determined in step S320 to the base station 120. The base station 120, having been received information on the handover mode determined from the apparatus 200 for determining a handover, may determine a handover of the UAM aircraft 111, 112, and 113 according to the corresponding mode.

With reference to FIG. 6, the difference between the first mode and the second mode with different handover conditions will be described.

Since a ground network provides communication services to an entire region on a map, whereas an airborne network provides communication services over only a specific width and a specific altitude range (e.g., from an altitude of 300 meters to an altitude of 600 meters) on a predetermined flight route, in the UAM operation system according to an embodiment of the present disclosure, the plurality of base stations 120 may be installed in a row along the route of the UAM aircraft 111, 112, and 113, as illustrated in FIG. 6. In addition, due to the characteristics of the antenna being tilted up at a specific angle in a specific direction (e.g., 20 degrees to 60 degrees), the plurality of base stations 120 may operate with cell coverage starting from a D_{offset} distance, rather than directly above the position of the base station 120, extending up to a Dₛ distance.

In the environment of the UAM operation system illustrated in FIG. 6, when operating a flight in a first direction 601, the UAM aircraft 111, 112, and 113 are moving in a direction in which the strength of signal beams in the serving cell weakens as the UAM aircraft 111, 112, and 113 move within the serving cell. In addition, when operating a flight in a second direction 602, the UAM aircraft 111, 112, and 113 are moving in a direction in which the strength of signal beams in the serving cell strengthens as the UAM aircraft 111, 112, and 113 move within the serving cell.

As described above, in the environment of the UAM operation system, when the UAM aircraft 111, 112, and 113 are operating a flight in the first direction 601 within the serving cell, the signal of the serving cell gradually weakens as the UAM aircraft moves, but when the UAM aircraft is near the target cell coverage, the signal of the target cell gradually increases, and the UAM aircraft may compare the signal strength of the corresponding cells and perform a handover to a cell with a greater signal strength.

In contrast, in the environment of the UAM operation system, when the UAM aircraft 111, 112, and 113 are operating a flight in a second direction 602 within the serving cell, the distance to the serving cell gradually gets closer as the UAM aircraft moves. Therefore, even as the handover occasion gradually approaches, the signal strength with the serving cell gradually increases. Once beyond the cell coverage, the signal quality suddenly deteriorates, which may cause problems when the normal handover operation of the ground network operates on the criteria that the signal strength of the serving cell is a predetermined level or below, and the like. Since the signal strength of the serving cell is relatively higher than that of the target cell even at a position where a handover should be performed due to cell coverage, the handover is not triggered by the normal handover operation of the ground network. Then, the signal strength of the serving cell drops sharply once beyond the cell coverage, and it may already be difficult for the serving cell to transmit or receive data while the handover procedure is being performed, causing the problem of a handover failure or degradation of quality in the wireless link.

The apparatus 200 for determining a handover may determine a mode among the first mode and the second mode, which have different handover conditions depending on the movement direction of the UAM aircraft 111, 112, and 113, as the handover mode, thereby preventing a handover failure or degradation of quality in the wireless link in advance. Here, the apparatus 200 for determining a handover may determine the handover mode to be the first mode when the UAM aircraft 111, 112, and 113 are moving in a direction in which the strength of signal beam of the serving cell weakens, and the second mode when the UAM aircraft 111, 112, and 113 are moving in a direction in which the strength of signal beam of the serving cell strengthens. Here, since the UAM aircraft 111, 112, and 113 operate a flight in accordance with a preset flight route and a preset flight plan, the apparatus 200 for determining a handover may identify information on the movement direction of the UAM aircraft 111, 112, and 113, and may determine whether the UAM aircraft 111, 112, and 113 is moving in a direction in which the strength of signal beam of the serving cell strengthens or in a direction in which the strength of signal beam of the serving cell weakens, and may determine a mode among the first mode and the second mode.

The control of handover of the UAM aircraft 111, 112, and 113 to the first mode or the second mode is performed by the base station 120. The first mode may include, as a handover condition, at least one of when the signal strength of the serving cell is less than a preset first threshold, when the signal strength of the target cell is greater than the signal strength of the serving cell, and when the signal strength of the serving cell is less than a preset second threshold and the signal strength of the target cell is greater than a preset third threshold. The second mode may include, as a handover condition, at least one of when the signal strength of the serving cell is greater than a preset fourth threshold, and when the signal strength of the target cell is greater than a preset fifth threshold.

In addition, the filtering value that determines the number of times the reference signals received power (RSRP) and reference signals received quality (RSRQ) are averaged in the first mode and the second mode may be set differently. In addition, to prevent ping-pong, the hysteresis value may be set differently in the first mode and the second mode. For example, the hysteresis value may be set to be smaller in the second mode than in the first mode, and the filtering value may be set to be greater in the second mode than in the first mode. When the hysteresis value is set to be smaller in the second mode than in the first mode and the filtering value is set to be greater in the second mode than in the first mode, the measurement reports transmitted by the UAM aircraft 111, 112, and 113 to the base station 120 may reflect more up-to-date values, thereby triggering a handover faster in the second mode than in the first mode. With these settings, even if the handover is performed a little earlier in the second mode than in the first mode, the signal of the target cell will gradually get better as the UAM aircraft moves. Accordingly, a relatively more stable wireless communication environment may be built.

Meanwhile, the apparatus 200 for determining a handover may further obtain information on the movement direction of the UAM aircraft 111, 112, and 113 (S410), as well as the current position information on the UAM aircraft 111, 112, and 113 (S420), or further obtain the flight speed information on the UAM aircraft 111, 112, and 113 (S430), as illustrated in FIG. 4, and determine the handover mode more accurately based on the obtained information as the number of types of obtained information increases (S440).

In step S420, when the current position information on the UAM aircraft 111, 112, and 113 is obtained, it may be determined whether the UAM aircraft 111, 112, and 113 is moving in a direction in which the strength of signal beam of the serving cell weakens or in a direction in which the strength of signal beam of the serving cell strengthens, without referring to the preset flight routes and flight plans and the like of the UAM aircraft 111, 112, and 113.

In addition, the determination of whether the UAM aircraft 111, 112, and 113 are moving in a direction in which the strength of signal beam of the serving cell weakens or in a direction in which the strength of signal beam of the serving cell strengthens may be performed in various forms. For example, the measurement reports of the UAM aircraft 111, 112, and 113 may be input to a pre-learned artificial neural network model to determine a direction with an output of the artificial neural network model, or to determine a mode among the first mode and the second mode each having different handover conditions.

In addition, at step S430, the apparatus 200 for determining a handover may obtain the flight speed information on the UAM aircraft 111, 112, and 113, and determine timing of the handover by reflecting the flight speed information on the UAM aircraft 111, 112, and 113. For example, the apparatus 200 for determining a handover may determine timing to request a handover earlier when the flight speed of the UAM aircraft 111, 112, and 113 exceeds a predetermined value.

### <Second Embodiment>: FIG. 1, FIG. 2, FIG. 3, FIG. 5, and FIG. 6 are Referenced

The UAM aircraft 111, 112, and 113 operate a flight in the service region of the airborne network 101 along the preset flight routes, and transmit information on the movement direction of the UAM aircraft 111, 112, and 113 to the apparatus 200 for determining a handover that is included in the base station 120 or in conjunction with the base station 120.

Then, the communication unit 210 of the apparatus 200 for determining a handover receives and transmits information on the movement direction of the UAM aircraft 111, 112, and 113 to the processor unit 220 (S310).

Next, the processor unit 220 determine a mode among the first mode and the second mode each having different handover conditions between the plurality of wireless cells based on the information on the movement direction of the UAM aircraft 111, 112, and 113 (S320).

Further, the processor unit 220 may control the communication unit 210 to transmit information on the handover mode determined in step S320 to the base station 120. The base station 120, having been received information on the handover mode determined in step S320 from the apparatus 200 for determining a handover, may determine a handover of the UAM aircraft 111, 112, and 113 according to the corresponding mode.

With reference to FIG. 6, the difference between the first mode and the second mode with different handover conditions has been described above in the description of the first embodiment.

In the environment of the UAM operation system according to the embodiment of the present disclosure, when operating a flight in a first direction 601, the UAM aircraft 111, 112, and 113 are moving in a direction in which the strength of signal beams in the serving cell weakens as the UAM aircraft 111, 112, and 113 move within the serving cell. In addition, when operating a flight in a second direction 602, the UAM aircraft 111, 112, and 113 are moving in a direction in which the strength of signal beams in the serving cell strengthens as the UAM aircraft 111, 112, and 113 move within the serving cell.

As described above, the apparatus 200 for determining a handover may determine a mode among the first mode and the second mode each having different handover conditions depending on the movement direction of the UAM aircraft 111, 112, and 113, thereby preventing in advance a handover failure or degradation of quality of the wireless link that may occur when relying on the normal handover operation of the ground network. Here, the processor unit 220 of the apparatus 200 for determining a handover may compare the difference between the movement direction of the UAM aircraft 111, 112, and 113 and the direction of signal beam of the base station 120 to a preset threshold based on the information on the movement direction of the UAM aircraft 111, 112, and 113 obtained in step S510 and the direction of signal beam of the base station 120, determine the handover mode to be the first mode when the difference between the two directions is equal to or less than the preset threshold, but determine the handover mode to be the second mode when the difference between the two directions exceeds the preset threshold. Alternatively, instead of comparing the difference between the two directions to the threshold, the processor unit 220 of the apparatus 200 for determining a handover may determine the handover mode to be the first mode when the UAM aircraft 111, 112, and 113 are moving in a direction in which the strength of signal beam of the serving cell weakens, and the second mode when the UAM aircraft 111, 112, and 113 are moving in a direction in which the strength of signal beam of the serving cell strengthens as they move (S520).

Then, step S530 performed by base station 120 may be inferred from the description given above through the first embodiment. The control of handover of the UAM aircraft 111, 112, and 113 to the first mode or the second mode is performed by the base station 120. The first mode may include, as a handover condition, at least one of when the signal strength of the serving cell is less than a preset first threshold, when the signal strength of the target cell is greater than the signal strength of the serving cell, and when the signal strength of the serving cell is less than a preset second threshold and the signal strength of the target cell is greater than a preset third threshold. The second mode may include, as a handover condition, at least one of when the signal strength of the serving cell is greater than a preset fourth threshold, and when the signal strength of the target cell is greater than a preset fifth threshold.

In addition, the filtering value that determines the number of times the RSRP and the RSRQ are averaged in the first mode and the second mode may be set differently. Further, to prevent ping-pong, the hysteresis value may be set differently in the first mode and the second mode. For example, the hysteresis value may be set to be smaller in the second mode than in the first mode, and the filtering value may be set to be greater in the second mode than in the first mode. When the hysteresis value is set to be smaller in the second mode than in the first mode and the filtering value is set to be greater in the second mode than in the first mode, the measurement reports transmitted by the UAM aircraft 111, 112, and 113 to the base station 120 may reflect more up-to-date values, thereby triggering a handover faster in the second mode than in the first mode. With these settings, even if the handover is performed a little earlier in the second mode than in the first mode, the signal of the target cell will gradually get better as the UAM aircraft moves. Accordingly, a relatively more stable wireless communication environment may be built.

Meanwhile, each step included in the method of determining a handover according to the embodiments described above may be implemented as a computer program including instructions for allowing a processor to perform the steps.

In addition, the computer program including instructions for allowing the processor to perform each step included in the method of determining a handover according to the embodiments described above may be recorded on a computer-readable storage medium.

As described above, according to an embodiment of the present invention, in determining a handover between wireless cells of an airborne network for aircraft such as UAM, a timing of a handover may be determined in movement direction. For example, a different handover condition may be applied depending on the movement direction, thereby enabling handover processing optimized for an airborne network environment. For example, when UAM aircraft is moving in a direction in which the strength of signal beam of the serving cell strengthens as it moves, a handover error may occur due to the characteristics of the airborne network environment in which the signal beam of the serving cell, which was strong at the boundary region of the serving cell and the target cell, is suddenly cut off when the normal handover procedure in the ground network environment is applied. However, smooth handover is supported through handover processing optimized for the characteristics of the airborne network environment.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

According to an embodiment of the present invention, in determining a handover between wireless cells of an airborne network for aircraft such as UAM, a different handover condition may be applied depending on the movement direction, thereby enabling handover processing optimized for an airborne network environment. These embodiments of the present invention may be used in various systems and related technologies that support wireless communications to aircraft, such as UAM.

1. A method for determining a handover to be performed by an apparatus for determining a handover, the method comprising:
obtaining information on a movement direction of an aircraft operating a flight along a preset flight route within a service region of an airborne network that includes a plurality of wireless cells;
determining a mode among a first mode and a second mode each having different handover conditions between the plurality of wireless cells based on the information on the movement direction; and
determining whether a handover of the aircraft or a communication device installed at the aircraft for airborne network is performed according to a handover condition corresponding to the determined mode.

2. The method of claim 1, wherein in the determining of the mode, the mode is determined further based on current position information on the aircraft on the preset flight route.

3. The method of claim 1, wherein in the determining of the mode, the mode is determined further based on flight speed information on the aircraft.

4. The method of claim 1, wherein in the determining of the mode, the mode is determined further based on directional information of a signal beam transmitted by a base station serving at least one wireless cell of the plurality of wireless cells.

5. The method of claim 1, wherein in the determining of the mode, one of the first mode and the second mode is determined according to a result of comparing a difference between a movement direction of the aircraft and a direction of a signal beam transmitted by a base station serving at least one wireless cell of the plurality of wireless cells to a preset threshold.

6. The method of claim 1, wherein in the determining of the mode, when the aircraft is moving in a direction in which strength of a signal beam of a serving cell weakens as the aircraft moves, a handover mode is determined to be the first mode, and when the aircraft is moving in a direction in which strength of the signal beam of the serving cell strengthens as the aircraft moves, the handover mode is determined to be the second mode.

7. The method of claim 1, wherein the first mode includes, as the handover condition, at least one of when signal strength of a serving cell is less than a preset first threshold, when signal strength of a target cell is greater than the signal strength of the serving cell, and when the signal strength of the serving cell is less than a preset second threshold and the signal strength of the target cell is greater than a preset third threshold, and
wherein the second mode includes, as the handover condition, at least one of when the signal strength of the serving cell is greater than a preset fourth threshold and when the signal strength of the target cell is greater than a preset fifth threshold.

8. The method of claim 1, wherein a hysteresis value is set to be smaller in the second mode than in the first mode, and a filtering value determining a number of times reference signal received power (RSRP) and reference signal received quality (RSRQ) are averaged is set to be greater in the second mode than in the first mode.

9. The method of claim 1, wherein in the determining of the handover, timing of the handover is determined based on a remaining distance from a current position of the aircraft to a boundary between a serving cell and a target cell, and
wherein the remaining distance in the second mode is set to be longer than the remaining distance in the first mode.

10. An apparatus for determining a handover, comprising:
a communication unit configured to perform communication with an aircraft operating a flight over a service region of an airborne network that includes a plurality of wireless cells along a preset flight route; and
a processor unit configured to control the communication unit,
wherein the processor unit, after obtaining information on a movement direction of the aircraft, determines a mode among a first mode and a second mode each having different handover conditions between a plurality of wireless cells based on the information on the movement direction, and determines whether a handover of the aircraft or a communication device installed at the aircraft for airborne network is performed according to a handover condition corresponding to the determined mode.

11. A non-transitory computer-readable storage medium storing a computer program, the computer program, when executed by a processor, comprising instructions to allow the processor to perform a method of determining a handover, the method comprising:
obtaining information on a movement direction of an aircraft operating a flight along a preset flight route within a service region of an airborne network that includes a plurality of wireless cells;
determining a mode among a first mode and a second mode each having different handover conditions between the plurality of wireless cells based on the information on the movement direction; and
determining whether a handover of the aircraft or a communication device installed at the aircraft for airborne network is performed according to a handover condition corresponding to the determined mode.

12. A method for determining a handover to be performed by an apparatus for determining a handover, the method comprising:
obtaining information on a movement direction of an aircraft operating a flight along a preset flight route within a service region of an airborne network that includes a plurality of wireless cells; and
determining a timing of a handover to be performed based on the information on the movement direction.

13. The method of claim 12, wherein the timing of the handover is determined based on a change in a strength of a signal received at the aircraft within a serving cell, the strength of the signal being corresponding to a distance between the aircraft and a base station of the serving cell.

14. The method of claim 12, wherein the timing of the handover is determined when the strength of the signal is higher than a preset threshold, in case that the strength of the signal increases and the distance between the aircraft and the base station increases.
